(19) United States
(12) Patent Application Publication
(10) Pub. No.: US 2024/0409467 A1
(43) Pub. Date: Dec. 12, 2024

(54) COMPOSITE BUILDING PANEL

(71) Applicant: ARMSTRONG WORLD INDUSTRIES, INC., Lancaster, PA (US)

(72) Inventor: Steven L. MASIA, Lancaster, PA (US)

(21) Appl. No.: 18/738,763

(22) Filed: Jun. 10, 2024

Related U.S. Application Data
(60) Provisional application No. 63/471,881, filed on Jun. 8, 2023.

(51) Int. Cl. C04B 28/30; B32B 3/26; B32B 5/02; B32B 5/26; B32B 13/02; B32B 13/14; C04B 14/04; C04B 14/28; C04B 18/26; C04B 111/00

(52) U.S. Cl. CPC C04B 28/30; B32B 3/266; B32B 5/022; B32B 5/266; B32B 13/02; B32B 13/14; C04B 14/045; C04B 14/28; C04B 18/265; B32B 2262/101; B32B 2607/00; C04B 2111/00612

(57) ABSTRACT

Described herein is a building panel comprising a body comprising a binder comprising MgO and MgSO₄; cellulosic fiber; and wherein the MgO and MgSO₄ are present in a molar ratio ranging from about 7:1 to about 9:1.

### CROSS-REFERENCE TO RELATED APPLICATIONS

The present application claims the benefit of priority to U.S. Provisional Patent Application Ser. No. 63/471,881, filed Jun. 3, 2023, the entirety of which is incorporated herein by reference.

### BACKGROUND

There is an increased demand for boards that are sustainable and, in particular, utilize recycled material. However, previous attempts at creating such board resulted in inferior acoustical performance and/or mechanical integrity. Thus, a need exists to improve upon building panels suitable for building systems without sacrifice of the necessary performance characteristics.

### BRIEF SUMMARY

According to some embodiments, the present invention is directed to a building panel comprising a body comprising: a binder comprising MgO and MgSO₄; cellulosic fiber; and wherein the MgO and MgSO₄ are present in a molar ratio ranging from about 3:1 to about 11:1.

Other embodiments of the present invention include a building panel comprising: a body comprising: a binder comprising MgO and MgSO₄; a recycled material comprising cellulosic fiber; wherein the body comprises a first major surface opposite a second major surface and a plurality of perforations extending from the first major surface to the second major surface of the body.

Other embodiments of the present invention include a building panel comprising: a body comprising: a binder comprising MgO and MgO—KH₂PO₄; cellulosic fiber; and wherein the MgO and MgO—KH₂PO₄ are present in a molar ratio ranging from about 1:1 to about 4:1.

Other embodiments of the present invention include a building panel comprising: a first facing layer having a first major surface opposite a second major surface; a body having a first major surface opposite a second major surface and a plurality of perforations extending from the first major surface of the body to the second major surface of the body, the body comprising: a particulate comprising cellulosic fiber; a binder comprising: a primary binder component comprising MgO; a secondary binder component that is different from the primary binder component; the primary binder component and the secondary binder component being present in a weight ratio ranging from about 1:1 to about 11:1; and wherein the second major surface of the first facing layer is adjacent to the first major surface of the body.

Other embodiments of the present invention include a building panel comprising a first facing layer having a first major surface opposite a second major surface, a plurality of perforations extending from the first major surface of the first facing layer to the second major surface of the first facing layer; a second facing layer having a first major surface opposite a second major surface, a plurality of perforations extending from the first major surface of the first facing layer to the second major surface of the second facing layer; a third facing layer having a first major surface opposite a second major surface; a body having a first major surface opposite a second major surface and a plurality of perforations extending from the first major surface of the body to the second major surface of the body, the body comprising: a particulate comprising cellulosic fiber; a binder comprising a primary binder component comprising MgO and a secondary binder component that is different from the primary binder component; wherein the first facing layer contacts the first major surface of the body, the second facing layer contacts the second major surface of the body, and the third facing layer contacts the first major surface of the first facing layers.

Other embodiments of the present invention include a building system comprising: a room environment comprising a floor surface; a plurality of vertical wall support studs; a ceiling structure wherein at least one of the previously discussed building panels are secured to one or more of the plurality of vertical wall support studs such that the building panel is located within 6 feet or less from the floor surface.

Other embodiments of the present invention include a method of manufacture of a building panel comprising: forming a blend by combining together a binder composition, a recycled material, and a water; flowing the blend into a mold having a geometry; hardening the blend in the mold such that the binder composition and the recycled material conform to the geometry of the mold, resulting in a building panel body; wherein the binder composition comprises MgO and MgSO₄ in a molar ratio ranging from about 3:1 to about 11:1.

Other embodiments of the present invention include a method of manufacture of a building panel comprising: forming a blend by combining together a binder composition, a recycled material, and a water; flowing the blend into a mold having a geometry; hardening the blend in the mold such that the binder composition and recycled material conform to the geometry of the mold, resulting in a building panel body; wherein the binder composition comprises MgO and MgO—KH₂PO₄ in a molar ratio ranging from about 1:1 to about 4:1.

Other embodiments of the present invention include a blend for the manufacture of building materials, the blend comprising: anhydrous MgO powder, anhydrous MgSO₄ powder; and a particulate filler comprising hydrated MgO and cellulosic fiber wherein the MgO and MgSO₄ in a molar ratio ranging from about 3:1 to about 11:1.

Other embodiments of the present invention include a blend for the manufacture of building materials, the blend comprising: anhydrous MgO powder, anhydrous KH₂PO₄ powder; and a particulate filler comprising hydrated MgO and cellulosic fiber wherein the MgO and KH₂PO₄ in a molar ratio ranging from about 1:1 to about 4:1. The blend may exist in the absence of liquid water (i.e., substantially free of liquid water).

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is top perspective view of a building panel according to the present invention;

FIG. 2 is a cross-sectional view of the building panel according to the present invention, the cross-sectional view being along the II line set forth in FIG. 1;

FIG. 3 is top perspective view of a building panel according to the present invention;

FIG. 4 is a cross-sectional view of the building panel according to the present invention, the cross-sectional view being along the IV line set forth in FIG. 3;

FIG. 5 is top perspective view of a building panel according to the present invention;

FIG. 6A is a cross-sectional view of the building panel according to the present invention, the cross-sectional view being along the V line set forth in FIG. 5;

FIG. 6B is a close-up of section VIB identified in FIG. 6A;

FIG. 7 is top perspective view of a building panel according to the present invention;

FIG. 8 is a cross-sectional view of the building panel according to the present invention, the cross-sectional view being along the VIII line set forth in FIG. 7;

FIG. 9 is top perspective view of a building panel according to the present invention;

FIG. 10 is a cross-sectional view of the building panel according to the present invention, the cross-sectional view being along the X line set forth in FIG. 8;

FIG. 11 is a building system comprising one or more of the building panels of FIGS. 1-10.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such.

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

Unless otherwise specified, all percentages and amounts expressed herein and elsewhere in the specification should be understood to refer to percentages by weight. The amounts given are based on the active weight of the material. According to the present application, the term “about” means +/−5% of the reference value. According to the present application, the term “substantially free” less than about 0.1 wt. % based on the total of the referenced value.

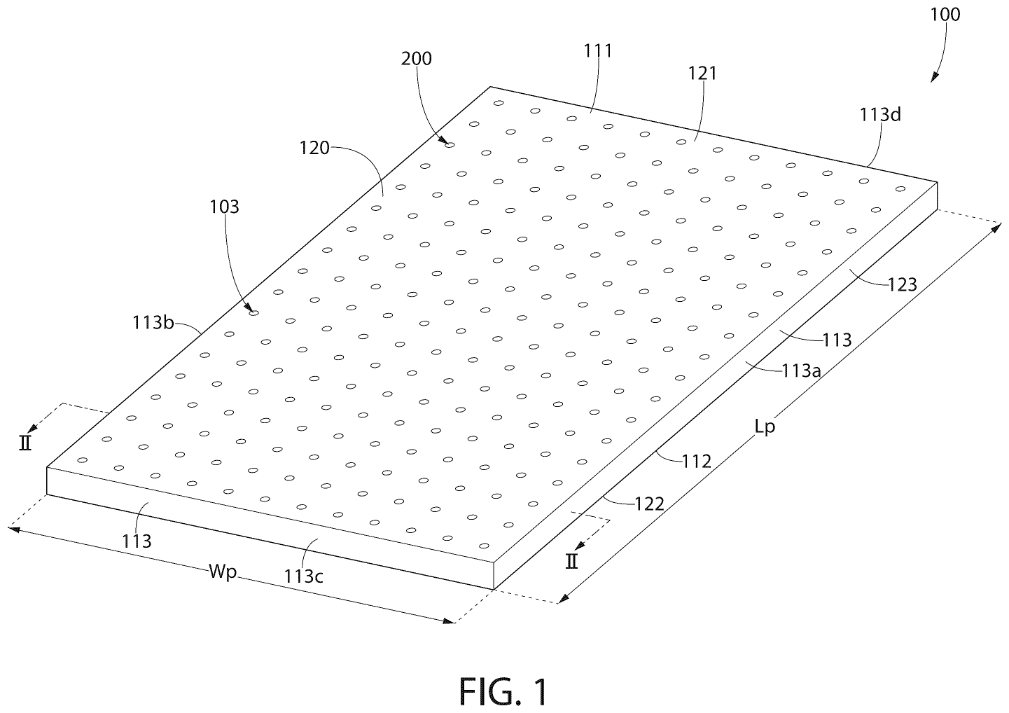

Referring to FIG. 1, a building panel 100 of the present invention may comprise a first exposed major surface 111 opposite a second exposed major surface 112. The ceiling panel 100 may further comprise a side exposed surface 113 that extends between the first exposed major surface 111 and the second exposed major surface 112, thereby defining a perimeter of the ceiling panel 100.

The side exposed surface 113 may comprise a first side surface 113a opposite a second side surface 113b and a third side surface 113c opposite a fourth side surface 113d. The first and second side surfaces 113a, 113b may be substantially parallel. The third and fourth side surfaces 113c, 113d may be substantially parallel. The first and second side surfaces 113a, 113b may be substantially orthogonal to the third and fourth side surface 113c, 113d. The first side surface 113a may intersect the third side surface 113c and the fourth side surface 113d. The second side surface 113b may intersect the third side surface 113c and the fourth side surface 113d.

The building panel 100 may have a panel width W_{P} as measured by the distance between the first side surface 113a and the second side surface 113b. The panel width W_{P} may range from about 12 inches to about 48 inches—including all widths and sub-ranges there-between. The building panel 100 may have a panel length L_{P} as measured by the distance between the third side surface 113c and the fourth side surface 113d. The panel length L_{P} may range from about 12 inches to about 96 inches—including all widths and sub-ranges there-between.

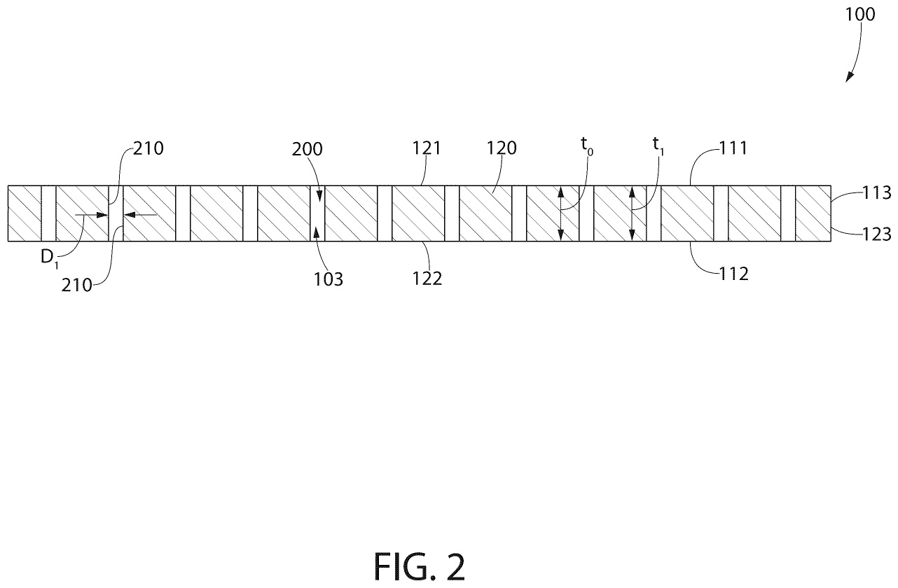

Referring now to FIGS. 1 and 2, the building panel 100 of the present invention may have a panel thickness t₀ as measured from the first exposed major surface 111 to the second exposed major surface 112. The panel thickness t₀ may range from about 0.25 inch to about 1.0 inch—including all values and sub-ranges there-between.

The building panel 100 may comprise a body 120 having an upper surface 121 opposite a lower surface 122 and a body side surface 123 that extends between the upper surface 122 and the lower surface 121, thereby defining a perimeter of the body 120. The body 120 may have a body thickness t₁ that extends from the upper surface 121 to the lower surface 122. The body thickness t₁ may range from about 0.25 inch to about 1 inch—including all values and sub-ranges there-between.

Although not pictured, the building panel 100 may comprise one or more additional layers coupled to the upper surface 121 of the body 120 and/or the lower surface of the body 120. Although not pictured, the building panel 100 may comprise one or more additional layers coupled to the side surface 123 the body 120.

The body 120 may comprise a plurality of perforations 200 that extend from the upper surface 121 to the lower surface 122 of the body 120. Each of the plurality of perforations 200 extend continuously between the upper surface 121 and the lower surface 122 of the body 120. Each of the plurality of perforations 200 form an open channel that provide for fluid communication through the body 120 between the upper surface 121 and the lower surface 122.

Each of the plurality of perforations 200 may be circumscribed by a perforation wall 210 extending from the upper surface 121 of the body 120 toward the lower surface 122 of the body 120. The perforation wall 210 may extend continuously from the upper surface 121 of the body 120 toward the lower surface 122 of the body 120. Each of the plurality of perforations 200 may have a perforation volume as defined by the volume contained within the perforation wall 210 between the upper surface 121 and the lower surface 122 of the body 120.

Each of the plurality of perorations 200 have a diameter D₁ as measured by the distance between the body perforation wall 210. The first diameter D₁ of each of the plurality of perforations 200 may range from about 50 mils to about 500 mils—including all diameters and sub-ranges there-between. In some embodiments, the first diameter D₁ of each of the plurality of perforations 200 may range from about 200 mils to about 250 mils—including all diameters and sub-ranges there-between.

The plurality of perforations 200 may be present on the body 120 in a perforation density ranging from about 20 perforations/ft² to about 15,000 perforations/ft²—including all perforation densities and sub-ranges there-between. In some embodiments, the plurality of perforations 200 may be present on the body 120 in a perforation density ranging from about 100 perforations/ft² to about 200 perforations/ft²—including all perforation densities and sub-ranges there-between.

The building panel 100 may also comprise a plurality of perforations 103 (also referred to as “panel perforations” 103) that are formed by the plurality of perforations 120 of the body 120 (also referred to as “body perforations” 200). In some embodiments, the plurality of panel perforations 103 may extend from the first exposed major surface 111 to the second exposed major surface 112. Each of the plurality of panel perforations 103 may extend continuously between the first exposed major surface 111 and the second exposed major surface 112 of the building panel 100.

As discussed in greater detail herein, the plurality of perforations 200 located within the body 120 may provide for airflow through the body 120 between the upper surface 121 and the lower surface 122. The plurality of panel perforations 103 may provide for airflow through the building panel 100 between the first exposed major surface 111 and the second exposed major surface 112.

The plurality of perforations 200 having the aforementioned diameter and thickness relationships result in a building panel 100 that is a capable of allowing for airflow through the building panel 100 between the first major exposed surface 111 and the second major exposed surface 112.

The airflow results in the building panel capable of exhibiting acoustical performance—thereby allowing the building panel to function as an acoustical building panel. Specifically, the airflow may allow the building panel to exhibit noise reducing characteristics quantified by a Noise Reduction Coefficient (NRC) rating, as described in American Society for Testing and Materials (ASTM) test method C423. This rating is the average of sound absorption coefficients at four ⅓ octave bands (250, 500, 1000, and 2000 Hz), where, for example, a system having an NRC of 0.90 has about 90% of the absorbing ability of an ideal absorber. A higher NRC value indicates that the material provides better sound absorption and reduced sound reflection.

The building panel 100 may exhibit an NRC of at least about 0.2 as measured between the first major exposed surface 111 and the second major exposed surface 112. In some embodiments, the building panel 10 have an NRC ranging from about 0.2 to about 0.70—including all value and sub-ranges there-between. In some embodiments, the building panel 10 have an NRC ranging from about 0.25 to about 0.60—including all value and sub-ranges there-between.

The building panel 100 may exhibit an airflow resistance ranging from about 10 to about 5,000 rayls as measured between the first major exposed surface 111 and the second major exposed surface 112.

The body 120 may comprise a binder. The body 120 may comprise a filler component. The body 120 may comprise a blend of the binder and the filler component.

The binder may be present in an amount ranging from about 40 wt. % to about 99 wt. % based on the total weight of the body 120—including each percent and sub-range there-between. The binder may be present in an amount ranging from about 63 wt. % to about 71 wt. % based on the total weight of the body 120—including each percent and sub-range there-between.

The filler component may comprise a fibrous component. The binder may form an inorganic matrix material. The binder may further comprise a latex. The filler component may be dispersed throughout the inorganic matrix material formed by the binder.

The body 120 may comprise the filler component dispersed throughout the binder. The body 120 may comprise the filler component dispersed throughout the inorganic matrix material formed by the binder. The body 120 may comprise the filler component dispersed uniformly throughout the binder. The body 120 may comprise the filler component dispersed uniformly throughout the inorganic matrix material formed by the binder.

The binder may comprise a primary binder component that includes magnesium oxide (MgO). The binder may comprise the primary binder component and optionally a secondary binder component that is different from the primary binder component-whereby the primary binder component and the secondary binder component are both capable of being hydrated in the presence of liquid water. The primary binder component and the secondary binder component may be different.

The primary binder component and the secondary binder component may be present in a weight ratio ranging from about 1:1 to about 11:1—including all ratios and sub-ranges there-between. The secondary binder component may be selected from one or more of magnesium sulphate (e.g. MgSO₄), and/or monopotassium phosphate (KH₂PO₄).

In some embodiments, the secondary binder component may be substantially free of magnesium chloride (MgCl₂). In some embodiments, the secondary binder component may be free of magnesium chloride (MgCl₂). In some embodiments, the binder may be substantially free of magnesium chloride (MgCl₂). In some embodiments, the binder may be free of magnesium chloride (MgCl₂). The secondary binder component may be substantially free of components forming chloride ions. The secondary binder component may be free of components forming chloride ions. The binder may be substantially free of components forming chloride ions. The binder may be free of components forming chloride ions.

In an embodiment, the binder may comprise MgO and MgSO₄. The binder may comprise both MgO and MgSO₄ in a molar ratio ranging from about 3:1 to about 11:1—including all ratios and sub-ranges there-between. Phases of MgO—MgSO₄: H₂0 present in the reacted cementious admixture are desired to be 3:1:8; and 5:1:8′ other crystal phases of 1:1:5, 1:2:2; 1:2:3; 5:1-2; 5-1-3 and 5:1;7.

In some embodiments, the binder may comprise both MgO and MgSO₄ in a molar ratio ranging from about: 4.0:1 to about 10.0:1—including all ratios and sub-ranges there-between. In some embodiments, the binder may comprise both MgO and MgSO₄ in a molar ratio ranging from about: 5.0:1 to about 10.0:1—including all ratios and sub-ranges there-between. In some embodiments, the binder may comprise both MgO and MgSO₄ in a molar ratio ranging from about: 5.0:1 to about 9.0:1—including all ratios and sub-ranges there-between. In some embodiments, the binder may comprise both MgO and MgSO₄ in a molar ratio ranging from about: 6.0:1 to about 9.0:1—including all ratios and sub-ranges there-between. In some embodiments, the binder may comprise both MgO and MgSO₄ in a molar ratio ranging from about: 7.0:1 to about 9.0:1—including all ratios and sub-ranges there-between. In some embodiments, the binder may comprise MgO and MgSO₄ in a molar ratio ranging from about 7.5:1 to about 8.5:1—including all ratios and sub-ranges there-between. In some embodiments, the binder may comprise MgO and MgSO₄ in a molar ratio ranging from about 7.9:1 to about 8.3:1—including all ratios and sub-ranges there-between.

The MgO may be present in an amount ranging from about 29 wt. % to about 51 wt. % based on the total weight of the body 120—including all wt. % and sub-ranges there-between. The MgSO₄ may be present in an amount ranging from about 10 wt. % to about 22 wt. % based on the total weight of the body 120—including all wt. % and sub-ranges there-between.

In an alternative embodiment, the binder may comprise MgO and KH₂PO₄. The binder may comprise both MgO and KH₂PO₄ in a molar ratio ranging from about 1.0:1 to about 4.0:1—including all ratios and sub-ranges there-between. In some embodiments, the binder may comprise both MgO and KH₂PO₄ in a molar ratio ranging from about 1.0:1 to about 3.0:1—including all ratios and sub-ranges there-between. In some embodiments, the binder may comprise MgO and MgSO₄ in a molar ratio ranging from about 1.0:1 to about 2.0:1—including all ratios and sub-ranges there-between. In some embodiments, the binder may comprise MgO and MgSO₄ in a molar ratio ranging from about 1.0:1 to about 1.5:1—including all ratios and sub-ranges there-between.

In an alternative embodiment, the binder may comprise both MgO and KH₂PO₄ in a molar ratio ranging from about 1.0:1 to about 4.0:1—including all ratios and sub-ranges there-between. In some alternative embodiments, the binder may comprise both MgO and KH₂PO₄ in a molar ratio ranging from about 2.0:1 to about 4.0:1—including all ratios and sub-ranges there-between. In some alternative embodiments, the binder may comprise MgO and MgSO₄ in a molar ratio ranging from about 3.0:1 to about 4.0:1—including all ratios and sub-ranges there-between.

The binder may be present in an amount ranging from about 40 wt. % to about 70 wt. % based on the total dry-weight of the body 120—including all weight-percentages and sub-ranges there-between.

The latex may be present in an amount ranging from about 0.1 wt. % to about 5 wt. % based on the total weight of the body 120.

The phrase “dry-weight” refers to the weight of a referenced component without the weight of any free liquid carrier. Thus, when calculating the weight percentages of components in the dry-state, the calculation should be based solely on the solid components (e.g., binder, filler, etc.) and should exclude any amount of residual free liquid carrier (e.g., water, VOC solvent) that may still be present from a wet-state, which will be discussed further herein.

The term “free liquid carrier” refers to the presence of a liquid carrier not as part of a hydration reaction. Such free liquid carrier may be capable of evaporation from a mixture or blend. For instance, a blend of anhydrous MgO and liquid water—whereby the liquid water has not reacted with the anhydrous MgO—the liquid water is free liquid carrier. However, for hydrated MgO—i.e., MgO that has reacted with water—the presence of such water in the hydrated structure does not meet the free liquid carrier feature. Such water present in the hydrated structure cannot be evaporated.

In some embodiments, the binder may comprise both MgO and MgSO₄ in a molar ratio ranging from about 6.5:1 to about 9.5:1—including all ratios and sub-ranges there-between—whereby the binder is present in an amount ranging from about 40% wt. % to about 99 wt. % based on the total dry-weight of the body 120. In some embodiments, the binder may comprise both MgO and MgSO₄ in a molar ratio ranging from about 6.5:1 to about 9.5:1—including all ratios and sub-ranges there-between—whereby the binder is present in an amount ranging from about 65 wt. % to about 70 wt. % based on the total dry-weight of the body 120.

In some embodiments, the binder may comprise both MgO and KH₂PO₄ in a molar ratio ranging from about 1.0:1 to about 4.0:1—including all ratios and sub-ranged there-between—whereby the binder is present in an amount ranging from about 40 wt. % to about 99 wt. % based on the total dry-weight of the body 120. In some embodiments, the binder may comprise both MgO and KH₂PO₄ in a molar ratio ranging from about 1.0:1 to about 4.0:1—including all ratios and sub-ranged there-between—whereby the binder is present in an amount ranging from about 60 wt. % to about 99 wt. % based on the total dry-weight of the body 120. In some embodiments, the binder may comprise both MgO and KH₂PO₄ in a molar ratio ranging from about 1.0:1 to about 4.0:1—including all ratios and sub-ranged there-between—whereby the binder is present in an amount ranging from about 63 wt. % to about 71 wt. % based on the total dry-weight of the body 120.

The filler may have an average particle size ranging from about 10 microns to about 15,000 microns—including all sizes and sub-ranges there-between. In some embodiments, the filler may have an average particle size ranging from about 100 microns to about 15,000 microns—including all sizes and sub-ranges there-between.

The filler component may comprise a fibrous component. The fibrous component may comprise a cellulosic fiber. The fibrous component may comprise inorganic fiber.

The cellulosic fiber may be a wood fiber, bamboo fiber, or other natural fiber. In a preferred embodiment, the cellulosic fiber is a wood fiber. In a non-limiting embodiment, the wood fiber may comprise aspen wood fiber. The inorganic fiber may comprise mineral wool fiber. The cellulosic fiber may be a recycled material. The inorganic fiber may be a recycled material.

The filler may comprise a composite particulate. The composition particulate may be a discrete particulate that is a pre-formed blend of inorganic material and the cellulosic fiber. The composite particulate may be a recycled material.

The term “recycled material” may refer to post-consumer recycle (PCR) materials—such as materials that have been collected and re-gathered after an initial use in a consumer application (e.g., material gathered from previous building panels, whereby that material is processed back in to particulate form). The term “recycled material” may also refer to an intermediate waster product material—such as a material that formed as a byproduct or an excess waste product from a virgin material being processed into a consumer product (e.g., excess material that was removed in the formation of a building panel).

The filler may be present in an amount ranging from about 1 wt. % to about 60 wt. % based on the total dry-weight of the body 120—including all weight-percentages and sub-ranges there-between. In some embodiments, the filler may be present in an amount ranging from about 30 wt. % to about 37 wt. % based on the total dry-weight of the body 120—including all weight-percentages and sub-ranges there-between. In some embodiments, the filler may be present in an amount ranging from about 28 wt. % to about 37 wt. % based on the total weight of the body—including all percentages and sub-ranges there-between. In some embodiments, the filler may be present in an amount ranging from about 29 wt. % to about 34 wt. % based on the total weight of the body—including all percentages and sub-ranges there-between.

In some embodiments, the filler may comprise at least 10 wt. % of fibrous filler having a particle size ranging from 5,000 microns to about 15,000 microns—including all individual particle sizes and sub-range particle-sizes there-between.

In some embodiments, the filler may comprise PCR material in an amount ranging from a non-zero amount up to about 38 wt. % based on the total weight of the body.

In some embodiments, the binder may comprise both MgO and MgSO₄ in a molar ratio ranging from about 6.5:1 to about 9.5:1—including all ratios and sub-ranges there-between—whereby the filler is present in an amount ranging from about 30 wt. % to about 37 wt. % based on the total dry-weight of the body 120.

It has been surprisingly discovered that the body 120 formed with MgO and MgSO₄ at these molar ratios provides an unexpected improvement in mechanical strength—including when the body 120 is also formed in-part by recycled material, as discussed in greater detail herein.

In some embodiments, the binder may comprise both MgO and KH₂PO₄ in a molar ratio ranging from about 1.0:1 to about 4.0:1—including all ratios and sub-ranged there-between—whereby the filler is present in an amount ranging from about 30 wt. % to about 37 wt. % based on the total dry-weight of the body 120.

It has been surprisingly discovered that the body 120 formed with MgO and KH₂PO₄ at these molar ratios provides an unexpected improvement in mechanical strength—including when the body 120 is also formed in-part by recycled material, as discussed in greater detail herein.

The inorganic material of the composite particulate may comprise one or more of magnesium oxide, sodium silicate, magnesium sulfate, and calcium carbonate. The inorganic material of the composite particulate may comprise one or more of magnesium oxide, sodium silicate, magnesium sulfate, and calcium carbonate—whereby the inorganic material is recycled. In some embodiments, the composite particulate may be a recycled material of magnesium oxide, sodium silicate, magnesium sulfate, calcium carbonate, and a cellulosic fiber. The cellulosic fiber may be aspen wood fiber.

In some embodiments, the composite particulate may be a recycled material of magnesium oxide in an amount ranging from about 20 wt. to about 30 wt. % based on the total dry-weight of the composite particulate; sodium silicate in an amount ranging from about 10 wt. % to about 20 wt. % based on the total dry-weight of the composite particulate; magnesium sulfate in an amount ranging from about 1 wt. % to about 10 wt. % based on the total dry-weight of the composite particulate; calcium carbonate in an amount ranging from about 1 wt. % to about 10 wt. % based on the total dry-weight of the composite particulate; and a cellulosic fiber in an amount ranging from about 40 wt. % to about 60 wt. % based on the total dry-weight of the composite particulate. The cellulosic fiber may be aspen wood fiber.

The recycled material as the filler may be present in an amount ranging from about 1 wt. % to about 60 wt. % based on the total dry-weight of the body 120—including all weight-percentages and sub-ranges there-between. In such embodiments where the recycled material as the filler accounts for about 1 wt. % and about 30 wt. % of the dry-weight of the body 120, the body 120 may comprise a corresponding amount of virgin material (i.e., not recycled) as filler to account for the overall amount of filler to be present in combination with the binder in the body 120 (i.e., 30 wt. % to 60 wt. %). As a non-limiting example, the binder may be present in an amount of about 60 wt. % based on the total dry-weight of the body 120—whereby the recycled filler accounts for 35 wt. % of the dry-weight of the body 120 and a remaining 5 wt. % of virgin filler accounts for the dry-weight of the body 120.

In some embodiments, the filler may be entirely recycled material. In alternative embodiments, the filler may be formed of entirely virgin material.

The body 120 in the dry-state may have a first bulk density ranging from about 0.5 g/cm³ to about 1.01 g/cm³—including all integers and sub-ranges there between. The term “first bulk density” refers to the density as measured relative to the total volume V_{Total} of the body 120—whereby V_{Total} is defined by the volume resulting from the panel length L_{P}, panel width W_{P} and panel thickness t₀. The V_{Total} includes the volume occupied by the skeleton of the body 120 (i.e., the volume occupied by the binder, the volume occupied by the filler, etc.) as well as the volume occupied by any small voids existing within a microporous structure of the skeleton, as well as the volume occupied by the voids created by the perforations 200 extending through the body 120 of the building panel 100.

The body 120 in the dry-state may have a second bulk density ranging from about 0.8 g/cm³ to about 1.2 g/cm³—including all integers and sub-ranges there between. The term “second bulk density” refers to the density as measured relative to the body total volume V_{BTotal} of the body 120—whereby V_{BTotal} is defined by the volume resulting from the panel length L_{P}, panel width W_{P} and panel thickness t₀ minus the volume occupied by the voids created by the perforations 200. The V_{BTotal} includes the volume occupied by the skeleton of the body 120 as well as any small voids existing with a microporous structure formed within the skeleton of the body 120—but does not include the volume occupied by the larger voids created by the perforations 200 extending through the body 120 of the building panel 100.

The body 120 in the dry-state may have a skeletal density ranging from about 0.8 g/cm³ to about 1.5 g/cm³—including all integers and sub-ranges there between. The term “skeletal density” refers to the density as measured relative to only the volume occupied by the components that make up the skeleton of the body 120 (e.g., volume of the binder, volume of the filler) without accounting for the volume occupied by the voids within the body 120 due to the porous nature of the body 120 or the volume of the voids created by the perforations 200.

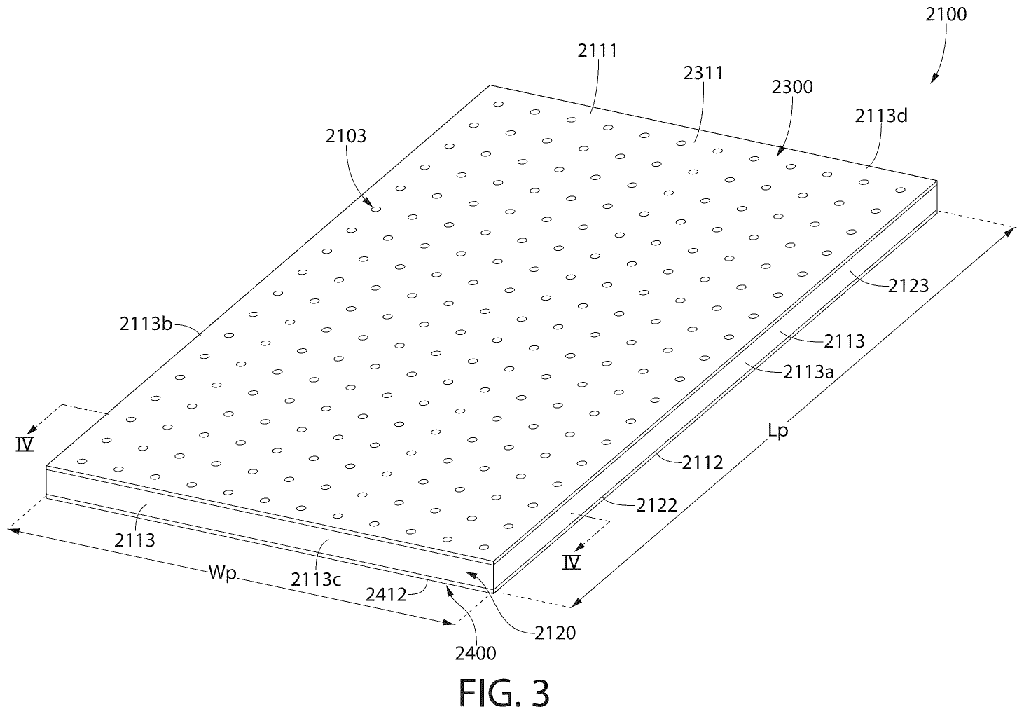

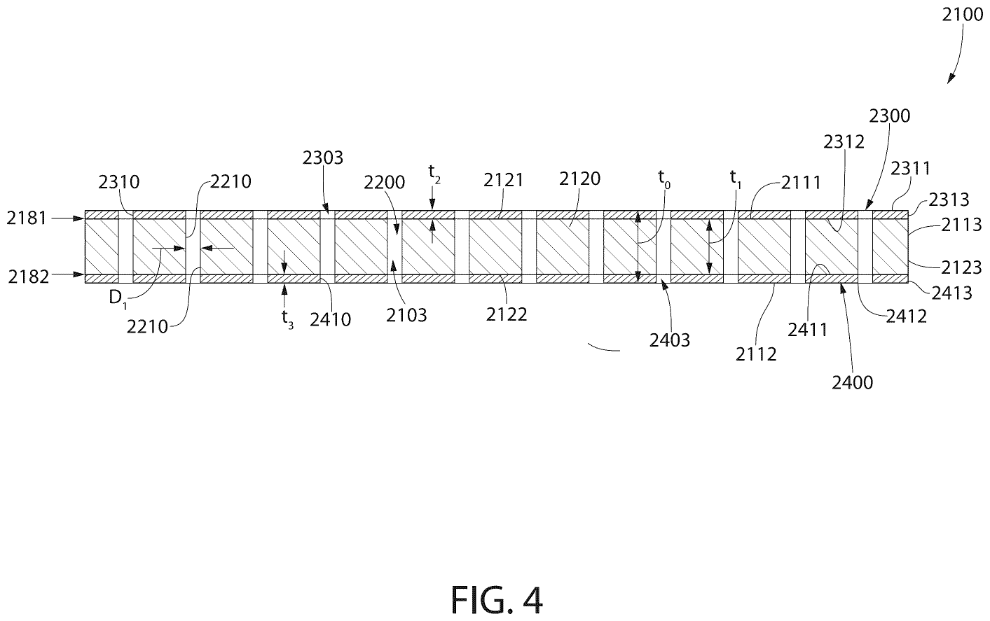

Referring now to FIGS. 3 and 4, a building panel 2100 according to another embodiment of the present invention will be described herein. The building panel 2100 is similar to the building panel 100 except as described herein below. The description of the building panel 100 above generally applies to the building panel 2100 described below except with regard to the differences specifically noted below. A similar numbering scheme will be used for the building panel 2100 as with the building panel 100 except that the 2000-series of numbers will be used.

The building panel 2100 may comprise a body 2120 and at least one facing layer 2300, 2400. In the embodiment shown in FIGS. 3 and 4, the building panel 2100 comprises a first facing layer 2300 and a second facing layer 2400. Although not shown, in other embodiments, the building panel 2100 may comprise only the first facing layer 2300. The first facing layer 2300 may be referred to as a first reinforcing layer 2300. The second facing layer 2400 may be referred to as a second reinforcing layer 2400.

The first facing layer 2300 may comprise a first major surface 2311 opposite a second major surface 2312 and a side surface 2313 extending between the first major surface 2311 and the second major surface 2312 of the first facing layer 2300. The first facing layer 2300 may have a first facing thickness t₂ as measured between the first major surface 2311 and the second major surface 2312 of the first facing layer 2300. The first facing thickness t₂ may range from about 20 mils to about 150 mils—including all thickness and sub-ranges there-between.

The first facing layer 2300 may comprise a plurality of perforations 2303. The plurality of perforations 2303 of the first facing layer 2300 may extend from the first major surface 2311 to the second major surface 2312 of the first facing layer 2300. The plurality of perforations 2303 of the first facing layer 2300 may extend continuously from the first major surface 2311 to the second major surface 2312 of the first facing layer 2300.

Each of the plurality of perforations 2303 of the first facing layer 2300 may be circumscribed by a perforation wall 2310 extending from the first major surface 2311 to the second major surface 2312 of the first facing layer 2300. The perforation wall 2310 may extend continuously from the first major surface 2311 to the second major surface 2312 of the first facing layer 2300. Each of the plurality of perforations 2303 of the first facing layer 2300 may have a diameter as measured by opposite sides of the perforation wall 2310—whereby the diameter of the plurality of perforations of the first facing layer 2300 may be substantially equal to the first diameter D₁ of the plurality of perforations 2200 of the body 2100.

In alternative embodiments not shown, the diameter of the plurality of perforations of the first facing layer 2300 may be different from the first diameter D₁ of the plurality of perforations 2200 of the body 2100. In alternative embodiments not shown, the diameter of the plurality of perforations of the first facing layer 2300 may be smaller from the first diameter D₁ of the plurality of perforations 2200 of the body 2100. In alternative embodiments not shown, the diameter of the plurality of perforations of the first facing layer 2300 may be greater from the first diameter D₁ of the plurality of perforations 2200 of the body 2100.

The plurality of perforations 2303 of the first facing layer 2300 may at least partially overlap with the plurality of perforations 2200 of the body 2100. In some embodiments, the plurality of perforations 2303 of the first facing layer 2300 fully overlap with the plurality of perforations 2200 of the body 2100. In some embodiments, the perforation wall 2310 of the plurality of perforations 2303 of the first facing layer 2300 may be flush with the perforation wall 2210 of the plurality of perforations 2200 of the body 2100.

The second facing layer 2400 may comprise a first major surface 2411 opposite a second major surface 2412 and a side surface 2413 extending between the first major surface 2411 and the second major surface 2412 of the second facing layer 2400. The second facing layer 2400 may have a second facing thickness t₃ as measured between the first major surface 2411 and the second major surface 2412 of the second facing layer 2400. The second facing thickness t₃ may range from about 20 mils to about 150 mils—including all thickness and sub-ranges there-between.

The second facing layer 2400 may comprise a plurality of perforations 2403. The plurality of perforations 2403 of the second facing layer 2400 may extend from the first major surface 2411 to the second major surface 2412 of the second facing layer 2400. The plurality of perforations 2403 of the second facing layer 2400 may extend continuously from the first major surface 2411 to the second major surface 2412 of the second facing layer 2400.

Each of the plurality of perforations 2403 of the second facing layer 2400 may be circumscribed by a perforation wall 2410 extending from the first major surface 2411 to the second major surface 2412 of the second facing layer 2400. The perforation wall 2410 may extend continuously from the first major surface 2411 to the second major surface 2412 of the second facing layer 2400. Each of the plurality of perforations 2403 of the second facing layer 2400 may have a diameter as measured by opposite sides of the perforation wall 2410—whereby the diameter of the plurality of perforations of the second facing layer 2400 may be substantially equal to the first diameter D₁ of the plurality of perforations 2200 of the body 2100.

In alternative embodiments not shown, the diameter of the plurality of perforations of the second facing layer 2400 may be different from the first diameter D₁ of the plurality of perforations 2200 of the body 2100. In alternative embodiments not shown, the diameter of the plurality of perforations of the second facing layer 2400 may be smaller from the first diameter D₁ of the plurality of perforations 2200 of the body 2100. In alternative embodiments not shown, the diameter of the plurality of perforations of the second facing layer 2400 may be greater from the first diameter D₁ of the plurality of perforations 2200 of the body 2100.

The plurality of perforations 2403 of the second facing layer 2400 may at least partially overlap with the plurality of perforations 2200 of the body 2100. In some embodiments, the plurality of perforations 2403 of the second facing layer 2400 fully overlap with the plurality of perforations 2200 of the body 2100. In some embodiments, the perforation wall 2410 of the plurality of perforations 2403 of the second facing layer 2400 may be flush with the perforation wall 2210 of the plurality of perforations 2200 of the body 2100.

According to the embodiments where the plurality of perforations 2303 of the first facing layer 2300 fully overlap with the plurality of perforations 2200 of the body 2100 and the plurality of perforations 2403 of the second facing layer 2400 fully overlap with the plurality of perforations 2200 of the body 2100 and where the diameter of the plurality of perforations of the first facing layer 2300 is substantially equal to the first diameter D₁ of the plurality of perforations 2200 of the body 2100 and the diameter of the plurality of perforations of the second facing layer 2400 is substantially equal to the first diameter D₁ of the plurality of perforations 2200 of the body 2100—in such embodiments the perforation wall 2310 of the plurality of perforations 2303 of the first facing layer 2400, the perforation wall 2210 of the plurality of perforations 2200 of the body 2100, and the perforation wall 2410 of the plurality of perforations 2403 of the second facing layer 2400 may be flush to each other. In such embodiments, the plurality of perforations 2303 of the overall building panel 2100 may extend continuously from the first exposed major surface 2111 to the second exposed major surface 2112 of the building panel 2100—whereby the diameter of the plurality of perforations 2303 of the overall building panel 2100 is substantially constant.

The first facing layer 2300 may be positioned atop the upper surface 2121 of the body 2120. The second major surface 2312 of the first facing layer 2300 may face the upper surface 2121 of the body 2120. The second major surface 2312 of the first facing layer 2300 may contact the upper surface 2121 of the body 2120. A first interface 2181 may exist between the first facing layer 2300 and the body 2120. The first interface 2181 may exist between the second major surface 2312 of the first facing layer 2300 and the upper surface 2121 of the body 2120.

The first facing layer 2300 may be coupled to the body 2120. The first facing layer 2300 may be coupled to the upper surface 2121 of the body 2120. The second major surface 2312 of the first facing layer 2300 may be coupled to the body 2120. The second major surface 2312 of the first facing layer 2300 may be coupled to the upper surface 2121 of the body 2120. The first facing layer 2300 and the body 2120 may be coupled by adhesive.

The first facing layer 2300 may be formed of a fibrous material. The fibrous material may be a non-woven fibrous material. The fibrous material may be an inorganic fibrous material. In a non-limiting embodiment, the fibrous material may be selected from one or more of fiberglass, mineral wool, and combinations thereof.

The first facing layer 2300 may be a porous. The first facing layer 2300 may provide physical reinforcement to the underlying body 2120 thereby enhancing the mechanical strength of the resulting building panel 2100. The combination of the plurality of perforations 2303 of the first facing layer 2300 and the plurality of perforations 2200 of the body 2120 may impart enhanced mechanical strength of the underlying body 2120 without substantially interfering with the acoustical properties attributed to the plurality of perforations 2200 extending through the body 2120. The phrase “without substantially interfering with the acoustical properties” refers to the building panel 2100 maintaining at least 85% of the NRC performance of the body 2120 with the presence of the first facing layer 2300 as compared to the NRC performance of the body 2120 without the first facing layer 2300 applied thereto.

The second facing layer 2400 may be positioned below the lower surface 2122 of the body 2120. The first major surface 2411 of the second facing layer 2400 may face the lower surface 2122 of the body 2120. The first major surface 2411 of the second facing layer 2400 may contact the lower surface 2122 of the body 2120. A second interface 2182 may exist between the second facing layer 2400 and the body 2120. The second interface 2182 may exist between the first major surface 2411 of the second facing layer 2400 and the lower surface 2122 of the body 2120.

The second facing layer 2400 may be coupled to the body 2120. The second facing layer 2400 may be coupled to the lower surface 2122 of the body 2120. The first major surface 2411 of the second facing layer 2400 may be coupled to the body 2120. The first major surface 2411 of the second facing layer 2400 may be coupled to the lower surface 2122 of the body 2120. The second facing layer 2400 and the body 2120 may be coupled by adhesive.

The second facing layer 2400 may be formed of a fibrous material. The fibrous material may be a non-woven fibrous material. The fibrous material may be an inorganic fibrous material. In a non-limiting embodiment, the fibrous material may be selected from one or more of fiberglass, mineral wool, and combinations thereof.

The second facing layer 2400 may be a porous. The second facing layer 2400 may provide physical reinforcement to the underlying body 2120 thereby enhancing the mechanical strength of the resulting building panel 2100. The combination of the plurality of perforations 2403 of the second facing layer 2400 and the plurality of perforations 2200 of the body 2120 may impart enhanced mechanical strength of the underlying body 2120 without substantially interfering with the acoustical properties attributed to the plurality of perforations 2200 extending through the body 2120. The phrase “without substantially interfering with the acoustical properties” refers to the building panel 2100 maintaining at least 85% of the NRC performance of the body 2120 with the presence of the second facing layer 2400 as compared to the NRC performance of the body 2120 without the second facing layer 2400 applied thereto.

The first exposed major surface 2111 of the building panel 2100 may comprise the first facing layer 2300. The first exposed major surface 2111 of the building panel 2100 may comprise the first major surface 2311 of the first facing layer 2300. The first major surface 2311 of the first facing layer 2300 may form the first exposed major surface 2111 of the building panel 2100.

The second exposed major surface 2112 of the building panel 2100 may comprise the second facing layer 2400. The second exposed major surface 2112 of the building panel 2100 may comprise the second major surface 2412 of the second facing layer 2400. The second major surface 2412 of the second facing layer 2400 may form the second exposed major surface 2112 of the building panel 2100.

According to the embodiments where the building panel 2100 comprises at least one of the first facing layer 2300 and/or second facing layer 2400—the plurality of panel perforations 2103 may be visually concealed from the first exposed major surface 2111 of the building panel 2100 (when comprising the first facing layer 2300) and/or visually concealed from the second exposed major surface 2112 of the building panel 2100 (when comprising the second facing layer 2400).

The building panel 2100 may have a panel thickness t₀ as measured from the first exposed major surface 2111 to the second exposed major surface 2112. The panel thickness t₀ may range from about 0.3 inch to about 1.0 inch—including all values and sub-ranges there-between. In some embodiments, the panel thickness t₀ may range from about 0.33 inch to about 1.0 inch—including all values and sub-ranges there-between.

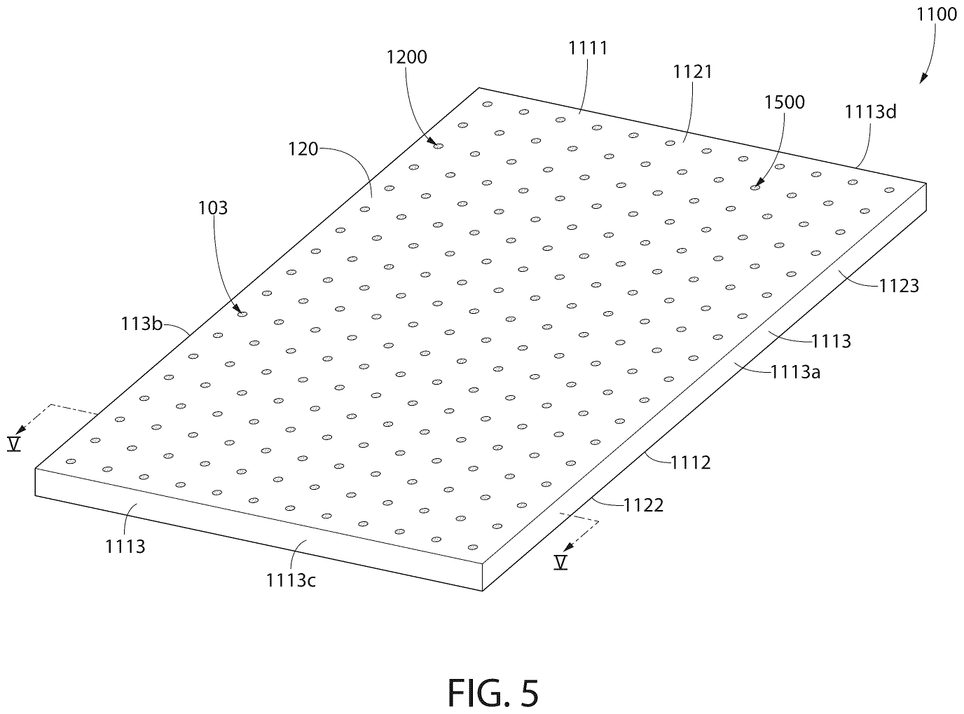

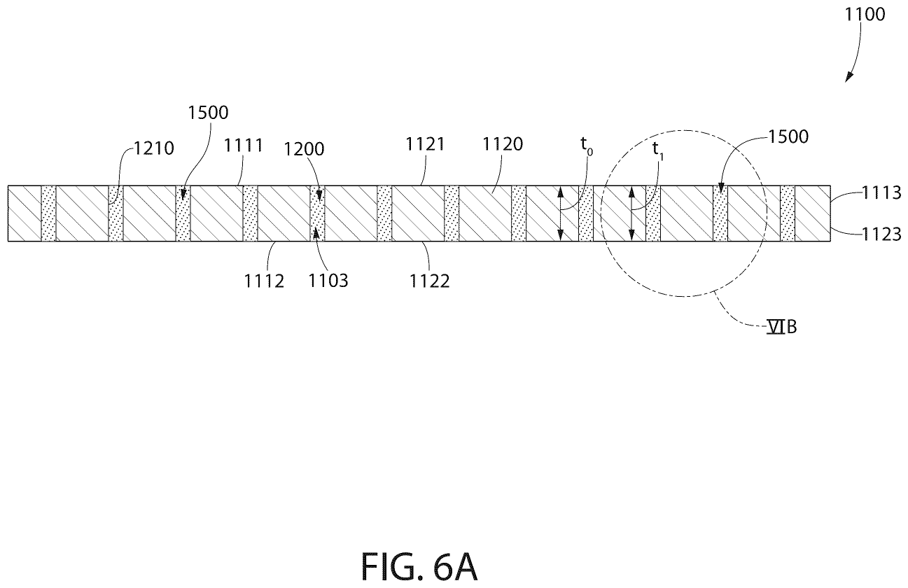

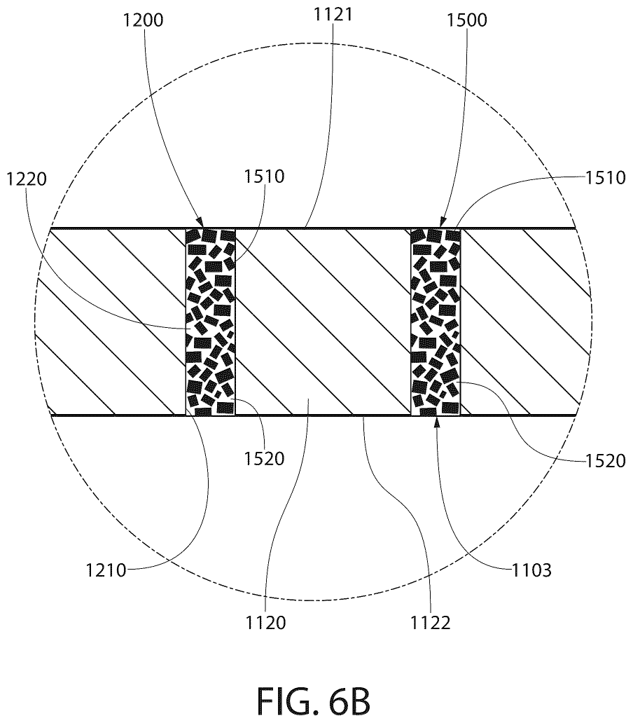

Referring now to FIGS. 5, 6A, and 6B, a building panel 1100 according to another embodiment of the present invention will be described herein. The building panel 1100 is similar to the building panel 100 except as described herein below. The description of the building panel 100 above generally applies to the building panel 1100 described below except with regard to the differences specifically noted below. A similar numbering scheme will be used for the building panel 1100 as with the building panel 100 except that the 1000-series of numbers will be used.

The body 1120 of building panel 1100 may comprise the plurality of perforations 1200 that extend from the upper surface 1121 to the lower surface 1122 of the body 1120. The building panel 1100 may further comprise an acoustical tuning structure 1500 that is positioned in at least one of the plurality of perforations 1200.

The acoustical tuning structure 1500 may comprise at least one acoustical particulate filler 1510 and at least one tuning pathway 1520. In some embodiments, the acoustical particulate filler 1510 may occupy a volume that is less than 95% of the perforation volume of each of the plurality of perforations 1200—whereby the remaining unoccupied volume is occupied by the tuning pathway 1520 of the acoustical tuning structure 1500. In some embodiments, the acoustical particulate filler 1510 may occupy a volume that is less than 60% of the perforation volume of each of the plurality of perforations 1200—whereby the remaining unoccupied volume is occupied by the tuning pathway 1520 of the acoustical tuning structure 1500. In some embodiments, the acoustical particulate filler 1510 may occupy a volume that is equal to about 1% to about 43% of the perforation volume of each of the plurality of perforations 1200—including all percentages and sub-ranges there-between. The tuning pathway 1520 is an open channel allowing for airflow to continue between the upper surface 1121 and the lower surface 1122 of the body 1120.

The combination of the acoustical particulate filler 1510 and the tuning pathway 1520 results allows for fine-tuning of the acoustical properties of the resulting building panel 1100. Specifically, mass production of the body 1100 comprising the plurality perforations 1200 may be formed each having substantially equal acoustical properties—whereby specific acoustical properties can then be further fine-tuned by the addition of the acoustical tuning structure 1500 to the resulting building panel 1100 depending on the desired application.

The acoustical particulate filler may include one of the aforementioned fillers present in the body 1120—e.g., PCR materials—as well as one or more inorganic particulates—such as diatomaceous earth, sodium silicate, gravel, and combinations thereof. The acoustical particulate filler 1510 may have a particle size ranging from about 60 microns to about 5,000 microns—including all sizes and sub-ranges there-between. In some embodiments, the acoustical tuning filler 1500 may comprise diatomaceous earth having a particle size ranging from about 60 microns to about 140 microns—including all sizes and sub-ranges there-between. In some embodiments, the acoustical particulate filler may comprise a fibrous material having a size of at least 5,000 microns.

The acoustical tuning structure 1500 may further comprise a binder that holds the acoustical particulate filler 1510 in place within each of the plurality of perforations 1200. The binder may be polymeric. Non-limiting examples of polymeric binder include epoxy, latex, and combinations thereof.

In some embodiments, the acoustical particulate filler 1510 may occupy about 1% to about 100% of the perforation volume—including all percentages and sub-ranges there-between. In some embodiments, the acoustical tuning filler 1500 may occupy about 25% to about 100% of the perforation volume—including all percentages and sub-ranges there-between. In some embodiments, the acoustical tuning filler 1500 may occupy about 50% to about 100% of the perforation volume—including all percentages and sub-ranges there-between. In some embodiments, the acoustical tuning filler 1500 may occupy about 75% to about 100% of the perforation volume—including all percentages and sub-ranges there-between.

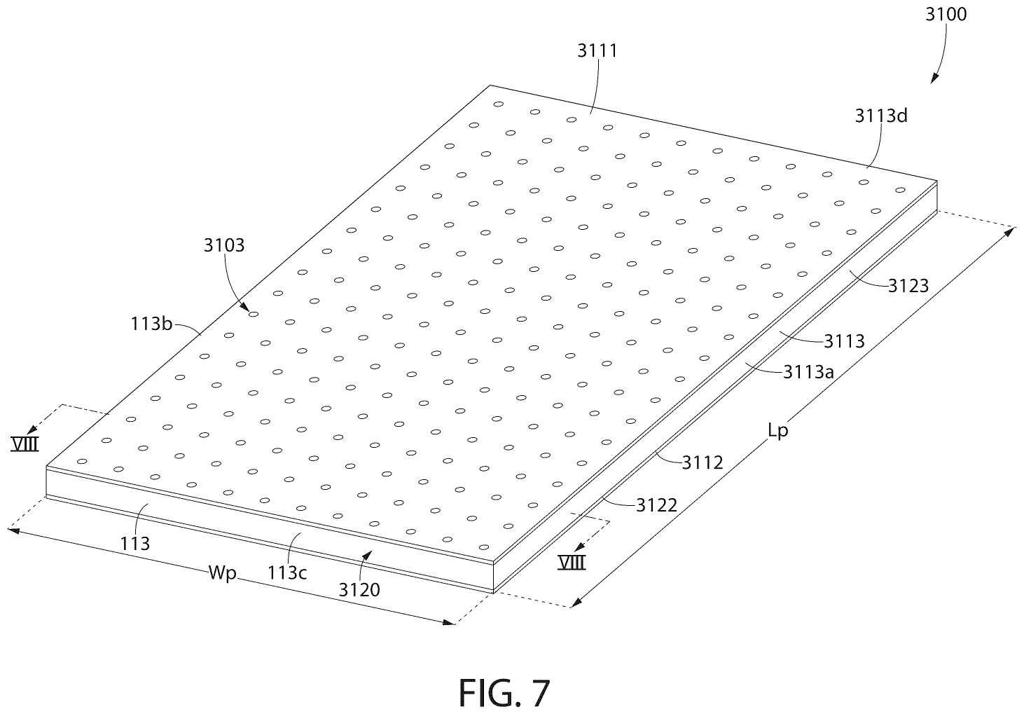

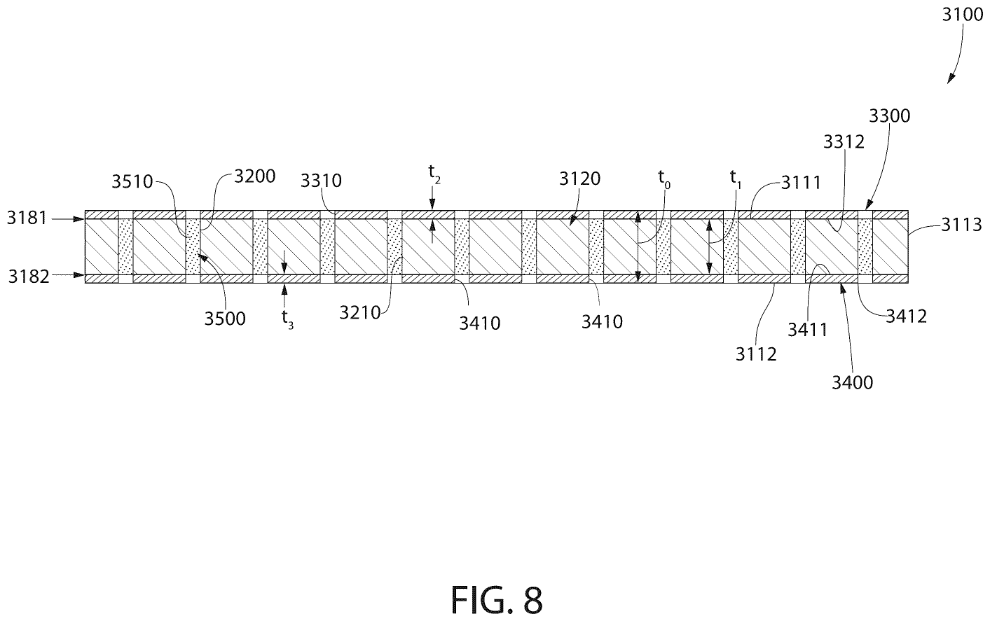

Referring now to FIGS. 7 and 8, a building panel 3100 according to another embodiment of the present invention will be described herein. The building panel 3100 is similar to the building panel 100, 1100, 2100 except as described herein below. The description of the building panel 100, 1100, and 2100 above generally applies to the building panel 3100 described below except with regard to the differences specifically noted below. A similar numbering scheme will be used for the building panel 3100 as with the building panel 100, 1100, 2100 except that the 3000-series of numbers will be used.

The building panel 3100 according to the present embodiment may comprise the plurality of perforations 3200, whereby the acoustical tuning structure 3500 is positioned within at least one of the plurality of perforations 3200. The building panel 3100 according to the present embodiment may further comprise at least one of the first facing layer 3300 and/or the second facing layer 3400.

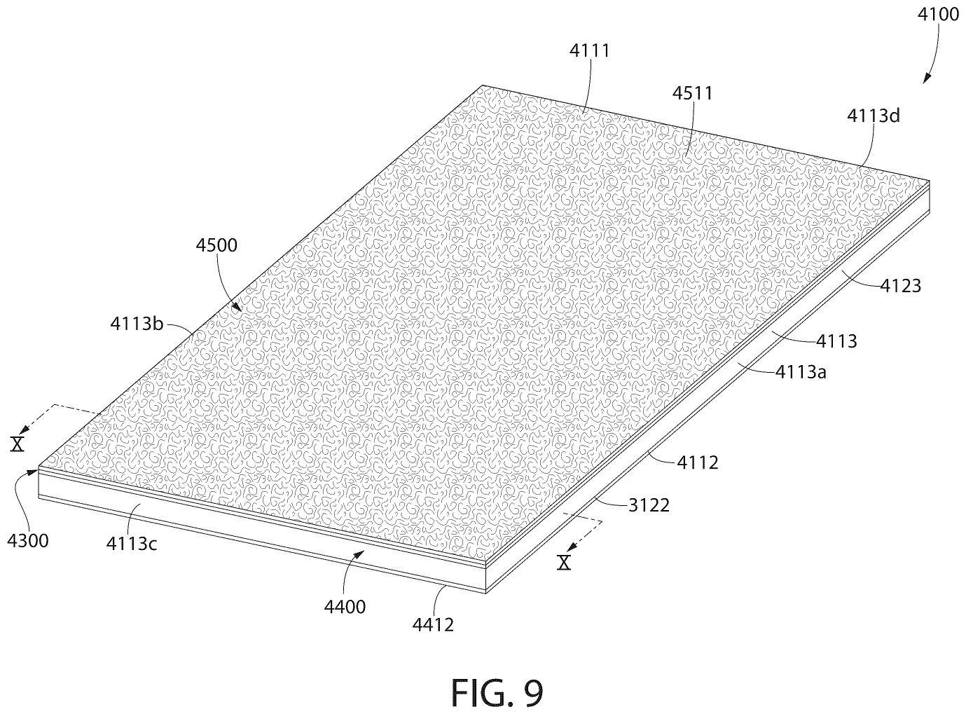

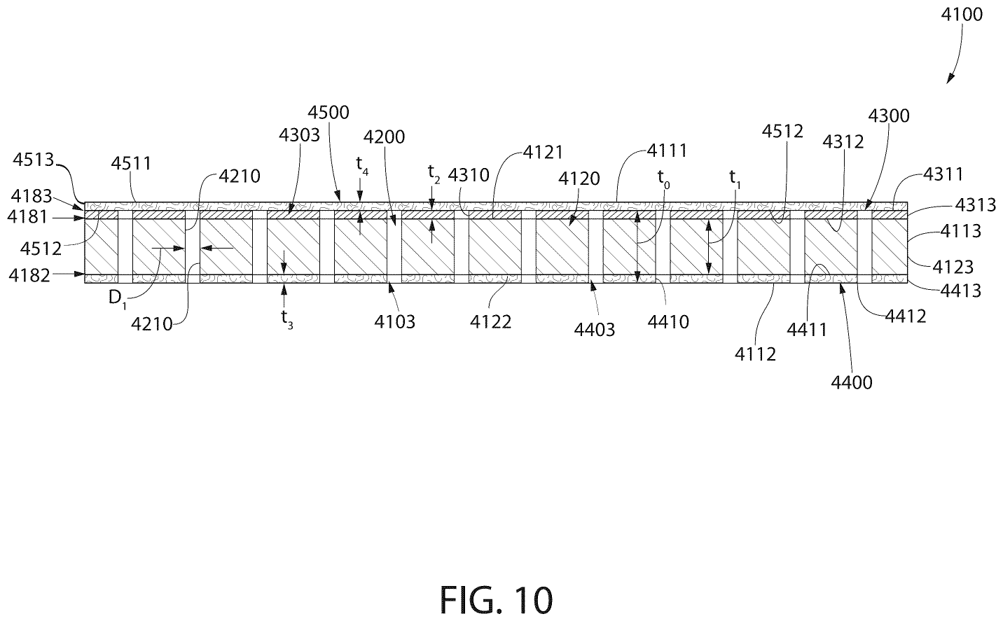

Referring now to FIGS. 9 and 10, a building panel 4100 according to another embodiment of the present invention will be described herein. The building panel 4100 is similar to the building panel 100, 1100, 2100, 3100 except as described herein below. The description of the building panel 100, 1100, 2100, and 3100 above generally applies to the building panel 4100 described below except with regard to the differences specifically noted below. A similar numbering scheme will be used for the building panel 4100 as with the building panel 100, 1100, 2100, 4100 except that the 4000-series of numbers will be used.

The building panel 4100 according to the present embodiment may comprise the plurality of perforations 4200, the first facing layer 4300, and the second facing layer 4400—as well as a third facing layer 4500. The third facing layer 4500 may be referred to as a “concealment layer” 4500. Although not shown, the building panel 4100 of the embodiments of FIGS. 9 and 10 may further comprise the tuning structure of the aforementioned embodiments.

The third facing layer 4500 may comprise a first major surface 4511 opposite a second major surface 4512 and a side surface 4513 extending between the first major surface 4511 and the second major surface 4512 of the third facing layer 4500. The first facing layer 4500 may have a third facing thickness t₄ as measured between the first major surface 4511 and the second major surface 4512 of the third facing layer 4500. The third facing thickness t₄ may range from about 20 mils to about 150 mils—including all thickness and sub-ranges there-between.

The third facing layer 4500 may be positioned atop the first major surface 4311 of the first facing layer 4300. The second major surface 4512 of the third facing layer 4500 may face the first major surface 4311 of the first facing layer 4300. The second major surface 4312 of the third facing layer 4500 may contact the first major surface 4311 of the first facing layer 4300. A third interface 4183 may exist between the third facing layer 4500 and the first facing layer 4300. The third interface 4183 may exist between the second major surface 4512 of the third facing layer 4500 and the first major surface 4311 of the first facing layer 4300. The third facing layer 4500 may be vertically offset from the body 4120 by the first facing layer 4300.

The third facing layer 4500 may be coupled to the first facing layer 4300. The first facing layer 4500 may be coupled to the first major surface 4311 of the first facing layer 4300. The second major surface 4512 of the third facing layer 4500 may be coupled to the first facing layer 4300. The second major surface 4512 of the third facing layer 4300 may be coupled to the first major surface 4311 of the first facing layer 4300. The third facing layer 4500 and the first facing layer 4300 may be coupled by adhesive.

The third facing layer 4500 may be formed of a fibrous material. The fibrous material may be a non-woven fibrous material. The fibrous material may be an inorganic fibrous material. In a non-limiting embodiment, the fibrous material may be selected from one or more of fiberglass, mineral wool, and combinations thereof.

The third facing layer 4500 may be a porous. The third facing layer 4500 may have an airflow resistance ranging from about 10 MKS Rayls to about 2,000 MKS Rayls—including all airflow resistances and sub-ranges there-between. In some embodiments, the first facing layer 2300 may have an airflow resistance ranging from about 40 MKS Rayls to about 300 MKS Rayls—including all airflow resistances and sub-ranges there-between. The unit of measure MKS rayls (Pa·s/m) is measured according to the methodology set forth in ASTM C522 “Standard Test Method for Airflow Resistance of Acoustical Materials.

The third facing layer 4500 may be substantially free of perforations. The third facing layer 4500 may provide visual concealment of the underlying body 2120 and underlying first facing layer 4300 when viewing from the first major surface 4511 of the third facing layer 4500. The third facing layer 4500 may visually conceal the underlying plurality of perforations 4200 of the underlying body 4120 without substantially interfering with the acoustical properties attributed to the plurality of perforations 4200 extending through the body 4120. According to the embodiments comprising the tuning structure, the third facing layer 4500 may provide visual concealment of the tuning structure contain within the plurality of perforations when viewing from the first major surface 4511 of the third facing layer 4500. According to the present embodiment, the third facing layer 4500 may visually conceal the underlying plurality of perforations 4200 as well as the underlying acoustical tuning structure without substantially interfering with the acoustical properties attributed to the plurality of perforations 4200 extending through the body 4120 filled with the acoustical tuning structure.

The phrase “without substantially interfering with the acoustical properties” refers to the building panel 4100 maintaining at least 85% of the NRC performance of the body 4120 with the presence of the third facing layer 4500 as compared to the NRC performance of the building panel without the third facing layer 4500 applied thereto.

The first exposed major surface 4111 of the building panel 4100 may comprise the third facing layer 4500. The second exposed major surface 4112 of the building panel 4100 may comprise the second facing layer 4400. The first exposed major surface 4111 of the building panel 4100 may comprise the first major surface 4511 of the third facing layer 4100. The second exposed major surface 4112 of the building panel 4100 may comprise the second major surface 4412 of the second facing layer 4400.

According to the present embodiment, the third facing layer 4500 may help contain the acoustical tuning structure within each of the plurality of perforations 4200 such that the acoustical particulate filler (and binder, for the embodiments that contain binder) does not unwantedly exit each of the plurality of perforations 4200 due to accidental damage that may occur during transportation, installation, or final usage.

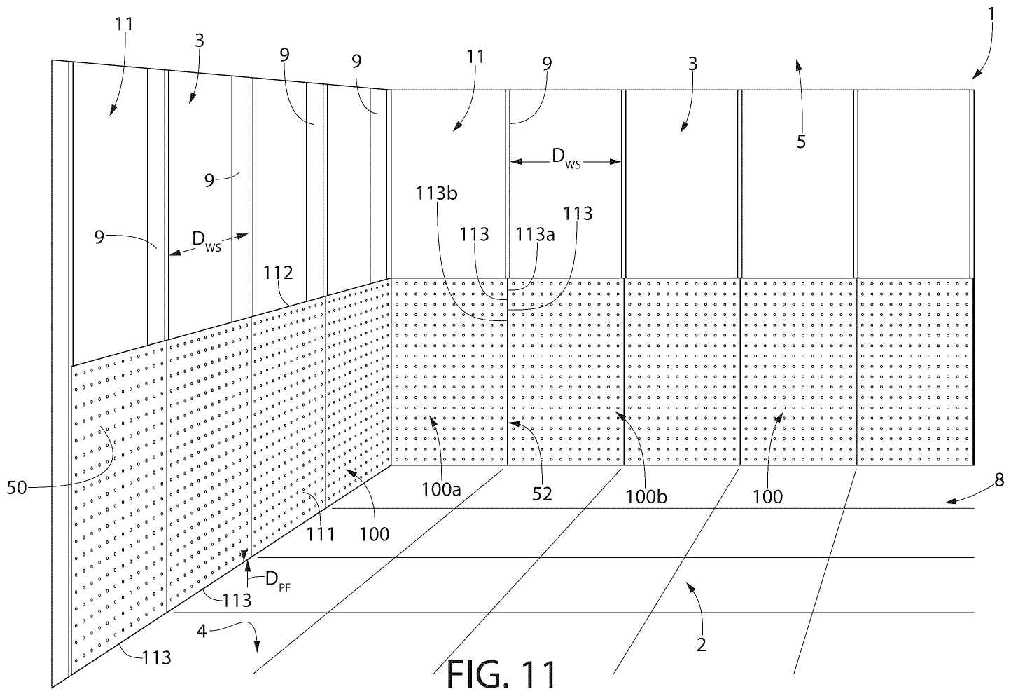

Referring to FIG. 11, the present invention may further include a building system 1 comprising one or more of the building panels 100 installed in an interior space 8. FIG. 9 only shows the building panel 100 installed, however, the following discussion applies to each of building panels 1100, 2100, 3100, and 4100.

The interior space 8 may comprise a floor surface 4 that is opposite a ceiling surface 5. The interior space 8 may further comprise a cavity space 3 and an active room environment 2. The cavity space 3 may provide a free volume for joists and/or wall stud 9 to be located within the building system 1. The active room environment 2 provides room for the building occupants during normal intended use of the building (e.g., in an office building, the active space would be occupied by offices containing computers, lamps, etc.). The floor surface 4 provides for building occupants to walk on within the room environment 2. The floor surface 4 may extend into the cavity space 3. The floor surface 4 may be formed a building material (e.g., wood flooring, concrete flooring, metal grate, etc.).

In the installed state, the building panels 100 may be supported in the interior space 8 by one or more of the wall studs 9 (for building panels 100 that function as wall panels) and/or one or more of the ceiling joists (for building panels 100 that function as ceiling panels-not pictured). In the installed state, the plurality of building panels 100 supported by the wall studs 9 may form a wall surface 50. In the installed state, the plurality of building panels 100 supported by the ceiling joists may form a ceiling surface 5.

The plurality of wall studs 9 may be arranged substantially parallel to each other. The plurality of wall studs 9 may be offset from each other by a distance D_{WS} of about 16 inches—as measured on center from each adjacent wall stud 9. The distance D_{WS} between wall studs 9 may provide for an open cavity volume 11. The open cavity volume 11 may be an unoccupied space within the building system 1. In other embodiments, insulation may be installed into the open cavity volume 11—non-limiting examples of insulation include sound insulation, thermal insulation, and combinations thereto.

The wall studs 9 may be an elongated body having a substantially vertical orientation—extending in a direction that spans between the floor surface 4 and the ceiling surface 5. Depending on the room layout design, the wall studs 9 may be oriented orthogonal to the floor surface 4—i.e., resulting in a wall surface 50 that is completely vertical (also referred to as a “vertical wall surface” 50). In other embodiments, the wall studs 9 may be oriented at an angle between about 46° to about 89° relative to the floor surface 4♯i.e., resulting in a wall surface 50 that is slanted (also referred to as a “slanted wall surface” 50).

Depending on the room layout design, the ceiling surface 5 may be substantially parallel to the floor surface 4—i.e., resulting in a ceiling surface 5 that is completely horizontal (also referred to as a “horizontal ceiling surface” 5). In other embodiments, the ceiling surface 5 may be oriented at an angle between about 1° to about 44° relative to the floor surface 4—i.e., resulting in a ceiling surface 5 that is slanted (also referred to as a “slanted ceiling surface” 5).

The cavity space 3 may exist behind each one of the plurality of building panels 100. The active room environment 2 may exists in front of each one of the plurality of building panels 100. The first exposed major surface 111 of the building panel 100 may face the active room environment 2. The second exposed major surface 112 of the building panel 100 may face the cavity space 3. As discussed further herein, the building panels 100 of the present invention have airflow properties required for the building panels 100 to functional as acoustical building panels—as discussed further herein.

In a non-limiting embodiment, the building panels 100 may be supported by the one or more of the wall studs 9 using a mechanical fastener (e.g., screw), adhesive, or combinations thereto. In a non-limiting embodiment, the building panels 100 may be support by the one or more ceiling joists using a mechanical fastener (e.g., screw), adhesive, or combinations thereof.

The building panels 100 may be positioned within building system 1 such that at least one of the side exposed surfaces 113 is located adjacent to the floor surface 4. Specifically, the first side surface 113a (or second side surface 113b) may be located adjacent to the floor surface 4—whereby in such arrangement, the wall panel 100 is vertically oriented in a sideways manner (not pictured). The wall panel 100 vertically oriented in the sideways manner may comprise the third side surface 113c and the fourth side surface 113d being substantially parallel to the elongated body of the wall studs 9—whereby each one of the third side surface 113c and/or fourth side surface 113d may overlap with a single wall stud 9. The wall panel 100 vertically oriented in the sideways manner may comprise the first side surface 113a and the second side surface 113b being substantially orthogonal to the elongated body of the wall studs 9—whereby each one of the first side surface 113a and/or second side surface 113b may overlap with a plurality of wall studs 9.

In other embodiments, the building panels 100 may be positioned within building system 1 such that at least one of the side surfaces 113 is located adjacent to the floor surface 4 such that the third side surface 113c (or fourth side surface 113d) may be located adjacent to the floor surface 4—whereby in such arrangement, the wall panel 100 is vertically oriented in an upstanding manner (as pictured in FIG. 3). The wall panel 100 vertically oriented in the upstanding manner may comprise the first side surface 113a and the second side surface 113b being substantially parallel to the elongated body of the wall studs 9—whereby each one of the first side surface 113a and/or second side surface 113b may overlap with a single wall stud 9. The wall panel 100 vertically oriented in the upstanding manner may comprise the third side surface 113c and the fourth side surface 113d being substantially orthogonal to the elongated body of the wall studs 9—whereby each one of the third side surface 113c and/or fourth side surface 113d may overlap with a plurality of wall studs 9.

A plurality of building panel seams 52 may exist between side surfaces 113 of two adjacent-most building panels 100. In a non-limiting example, FIG. 3 demonstrates that a first building panel 100a and a second building panel 100b may be positioned adjacent to each other, whereby a panel seam 52 is located where the first side surface 113a of the first building panel 100a is located adjacent to the second side surface 113b of the second building panel 100b. The building panel seam 52 may substantially overlap with the wall studs 9 in a vertical direction. Although not pictured, depending on the arrangement of building panels 100, the building panel seam 52 may substantially overlap with the wall studs 9 in a horizontal direction.

Although not pictured, the building panel seams 52 may be formed by the third side surface 113c of a first building panel and the fourth side surface 113d of a second building panel. Although not pictured, the building panel seams 52 may be formed by the first side surface 113a (or second side surface 113b) of a first building panel and the third side surface 113c (or fourth side surface 113d) of a second building panel.

In the installed state, the building panel 100 may be secured to one or more of the wall studs 9 such that the building panel 100 is located from the floor surface 4 by a panel-floor distance D_{PF}. The panel-floor distance DPF may be determined by the vertical distance spanning between the floor surface 4 and the most-proximate point on the building panel 100 from the floor surface 4. The panel-floor distance D_{PF} may range from zero to about 8 feet—including all distances and sub-ranges there-between. The panel-floor distance D_{PF} may range from zero to about 6 feet—including all distances and sub-ranges there-between. When the panel-floor distance D_{PF} is zero, the building panel 100 may be in direct contact with the floor surface 4. In some embodiments, the panel-floor distance D_{PF} is less than about 6 feet.

In other embodiments, the building panel 100 may also be installed such that it forms a ceiling surface (not pictured) and/or be position above the panel-floor distance D_{PF}.

The body 120, 1120, 2120, 3120 of the building panel 100, 1100, 2100, 3100 may be manufactured according to the following methodology. Although the following discussion may only refer to body 120, the such discussion applies to each of bodies 120, 1120, 2120, 3120.

A blend may be formed by combining together a binder composition and the filler component. The binder composition may be a blend of one or more of the MgO, MgSO₄, and/or KH₂PO₄ in an anhydrous state. The blend may further comprise an amount a liquid carrier, whereby the liquid carrier may comprise free liquid water. The binder composition before combining with the liquid carrier may be in an anhydrous state.

The liquid carrier may be present in an amount ranging from about 38 wt. % to about 45 wt. % based on the total weight of the blend—including all percentages and sub-ranges there-between.

In some embodiments, a powder blend may be formed before the addition of liquid water, whereby the powder blend comprises anhydrous MgO powder, MgSO₄ powder, and particulate filler—whereby the filler particulate comprises a hydrated MgO and cellulosic fiber. The particulate filler may have a particle size ranging from about 100 microns to about 15,000 microns. The MgO powder and MgSO₄ powder may be present in one of the aforementioned molar ratios.

In some embodiments, a powder blend may be formed before the addition of liquid water, whereby the powder blend comprises anhydrous MgO powder, KH₂PO₄ powder, and particulate filler—whereby the particulate filler comprises a hydrated MgO and cellulosic fiber. The particulate filler may have a particle size ranging from about 100 microns to about 15,000 microns. The MgO powder and KH₂PO₄ powder may be present in one of the aforementioned molar ratios.

Once combined with water, the blend may be agitated so that the binder composition and filler are uniformly mixed to create a flowable blend. The flowable blend may then be flowed into a mold. Once in the mold, the flowable blend may react such that the binder composition and the water cure to form the dried binder.

The mold may have a geometry that conforms to the dimensions of the body 120. The geometry of the mold may further conform to the plurality of perforations of the body 120. The term “geometry that conforms” refers to a geometry capable of producing the corresponding geometry of the resulting body 120. For instance, a geometry conforming to the dimensions of the body 120 will be a mold having a negative space capable of being filled with the flowable blend, whereby the negative space of the mold results in the body 120 having the aforementioned panel length L_{P}, panel width W_{P}, and panel thickness t₀. In another instance, a geometry conforming to the plurality of perforations of the body 120 will be a mold having a positive space capable of creating voids in the flowable blend that results in the body 120 having the aforementioned plurality of perforations 200.

The mold may be formed of a deformable material that does not adhere to the flowable blend. In a non-limiting embodiment, the mold may be formed of a silicone.

The binder composition and water react in the mold to harden—thereby forming the body 120. The body 120 may then be removed from the mold to form the building panel 100.

According to the embodiments comprising the acoustical tuning structure 1500, each of the plurality of perforations may be filled with the acoustical particulate filler (and binder) once the body has been removed from the mold.

According to the embodiments comprising the first facing layer 2300, 3300 and the second facing layer 2400, 3300, each of the facing layers may be bonded to the respective body 2120, 3120 once the body has been removed from the mold.

According to the embodiments comprising the acoustical tuning structure 1500 and at least one of the first facing layer 2300, 3300 and the second facing layer 2400, 3300, each of the plurality of perforations may be filled with the acoustical particulate filler (and binder) once the body has been removed from the mold and subsequently each of the facing layers may be bonded to the respective body 2120, 3120.

The following examples are prepared in accordance with the present invention. The present invention is not limited to the examples described herein.

### EXAMPLES

A series of experiments were performed to test the impact on strength of various amounts of MgO and MgSO4 on a building panel. The experiments further evaluated the impact of strength when the building panel included the presence of recycled particulate material and porosity of the panels according to the present invention. Each of the panels comprised a body formed of a formulation set forth below in Table 1—whereby the recycled particulate comprised MgO; sodium silicate; magnesium sulfate; calcium carbonate; and cellulosic fiber.

TABLE 1

| | Comp. | Comp. | | |
|---|---|---|---|---|
| | Ex. 1 | Ex. 2 | Ex. 1 | Ex. 2 |
| Binder Type | MgO | Gypsum | MgO:MgSO₄ | MgO:MgSO₄ |
| | | (CaSO₄•2H₂O) | | |
| Binder Amount | 90 wt. % | 100 wt. % | 69.3 wt. % | 42.9 wt. % |
| Recycled | 10 wt. % | — | 30.7 wt. % | 57.1 wt. % |
| Particulate | | | | |
| MgO:MgSO4 | — | — | 8:1 | 8:1 |
| Ratio | | | | |
| Porosity | N/A (no holes) | N/A (no holes) | 21% | 50% |
| Perforation | — | — | 250 mils | 500 mils |
| Diameter | | | | |
| Bulk Density | 0.69-1.50 | 0.54-0.85 | 0.86 | 0.56 |
| (g/cm3) | | | | |
| MOR (psi) | 2970 | 340 | 726 | 554 |
| NRC | 0 | 0.1 | Not Tested | 0.48 |

As demonstrated by Table 1, the binder system of the present invention comprising an 8:1 molar ratio of MgO:MgSO₄ (Examples 1 and 2) provides an unexpected improvement in modulus at rupture (“MOR”) strength as compared to gypsum board—most surprisingly even though the boards of Examples 1 and 2 comprise perforations throughout the body of the board as compared to the gypsum board being non-perforated. Moreover, while the MOR of the standard MgO board (Comparative Example 1) is higher than the MOR of Examples 1 and 2, the board of Example 1 was not able to be formed with perforations. Therefore, again, the boards of Examples 1 and 2 reflect an unexpected advancement as the binder system allows for the presence of perforations throughout the board—thereby imparting superior NRC performance (NRC of 0.48 for Example 2 as compared to an NRC of 0 for Comparative Example 1).

Furthermore, the strength of the body of the present invention is further reflected in the below test results of Table 2.

TABLE 2

| | Comp. | |
|---|---|---|
| | Ex. 2 | Ex. 1 |
| Edge Damage | 0.003 | 0.002 |
| 5 lbs. (inch) | | |
| Edge Damage | 0.006 | 0.004 |
| 10 lbs. (inch) | | |
| Edge Damage | 0.009 | 0.005 |
| 15 lbs. (inch) | | |
| Edge Damage | 0.015 | 0.01 |
| 30 lbs. (inch) | | |
| Load of Failure lb. | 16.8 | 18.3 |

As demonstrated by Table 2, the addition of the recycled component and binder system results in a board capable of better withstanding edge damage as compared to the gypsum counterpart.

What is claimed is:

1. A building panel comprising:
a body comprising:
a binder comprising MgO and MgSO₄;
a particulate comprising cellulosic fiber; and
wherein the MgO and MgSO₄ are present in a molar ratio ranging from about 7:1 to about 9:1.

2. The building panel according to claim 1, wherein the molar ratio of MgO to MgSO₄ ranges from about 7.9:1 to about 8.3:1.

3. The building panel according to claim 1, wherein the binder is present in an amount ranging from about 40% to about 99% based on the total weight of the building panel.

4. The building panel according to claim 1, wherein the body comprises a first major surface opposite a second major surface and a plurality of perforations extending from the first major surface to the second major surface of the body.

5. The building panel according to claim 4, wherein the plurality of perforations have an average diameter ranging from about 50 mils to about 500 mils.

6. The building panel according to claim 4, wherein the plurality of perforations are present in a perforation density ranging from about 20 perforation/ft² to about 15,000 perforation/ft².

7. The building panel according to claim 1, wherein the particulate is present in an amount ranging from about 1 wt. % to about 60 wt. % based on the total weight of the building panel.

8. The building panel according to claim 1, wherein the cellulosic material comprises recycled aspen wood fibers.

9. The building panel according to claim 8, wherein the recycled aspen wood fibers are present in an amount ranging from about 1 wt. % to about 37 wt. % based on the total weight of the building panel.

10. The building panel according to claim 4, wherein the body exhibits an NRC value ranging from about 0.25 to about 0.6.

11. A method of manufacture of a building panel comprising:
a) forming a blend by combining together a binder composition, a recycled material, and water;
b) flowing the blend into a mold having a geometry;
c) hardening the blend in the mold such that the binder composition and recycled material conform to the geometry of the mold, resulting in a building panel body;
wherein the binder composition comprises MgO and MgSO₄ in a molar ratio ranging from about 7:1 to about 9:1.

12. The method according to claim 11, wherein the molar ratio of MgO to MgSO₄ ranges from about 7.9:1 to about 8.3:1.

13. The method according to claim 11, wherein the binder composition is present in an amount ranging from about 40 wt. % to about 99 wt. % based on the total weight of the blend.

14. The method according to claim 11, wherein the recycled material is present in an amount ranging from about 1 wt. % to about 60 wt. % based on the total weight of the blend.

15. The method according to claim 11, wherein the geometry of the mold is such that the resulting building panel comprises a first major surface opposite a second major surface and a plurality of perforations extending from the first major surface to the second major surface of the body.

16. The method according to claim 11, wherein subsequent to c), the method further comprises d) coupling a first facing layer having a plurality of perforations to the first major surface of the body.

17. A blend for the manufacture of building materials, the blend comprising:
anhydrous MgO powder,
anhydrous MgSO₄ powder; and
a particulate filler comprising hydrated MgO and cellulosic fiber
wherein the MgO and MgSO₄ in a molar ratio ranging from about 6.5:1 to about 9.5:1.

18. The blend according to claim 17, wherein the anhydrous MgO powder and anhydrous MgSO₄ powder are present in an amount ranging from about 40 wt. to about 70 wt. % based on the total weight of the blend.

19. The blend according to claim 17, wherein the particulate filler has a particle size ranging from about 100 microns to about 15,000 microns.

20. The blend according to claim 17, wherein the particulate filler comprises:
the MgO in an amount ranging from about 20 wt. to about 30 wt. % based on the total dry-weight of the particulate filler;
sodium silicate in an amount ranging from about 10 wt. % to about 20 wt. % based on the total dry-weight of the particulate filler;
magnesium sulfate in an amount ranging from about 1 wt. % to about 10 wt. % based on the total dry-weight of the particulate filler;
calcium carbonate in an amount ranging from about 1 wt. % to about 10 wt. % based on the total dry-weight of the particulate filler; and
the cellulosic fiber in an amount ranging from about 40 wt. % to about 60 wt. % based on the total dry-weight of the particulate filler.
